(19) United States
(12) Patent Application Publication
(10) Pub. No.: US 2026/0004185 A1
(43) Pub. Date: Jan. 1, 2026

(54) INTELLIGENT CASE MANAGEMENT

(71) Applicant: SAP SE, Walldorf (DE)

(72) Inventors: Vikas Rohatgi, Bangalore (IN); Abhinav Kumar, Bangalore (IN)

(21) Appl. No.: 18/759,525

(22) Filed: Jun. 28, 2024

(51) Int. Cl. G06N 20/00

(52) U.S. Cl. CPC G06N 20/00

(57) ABSTRACT

Described herein are techniques for generating recommendations for plan items that are configured for manual activation. Sentries are conditions attached to a plan item such as events, tasks, or stages within a case plan. A plurality of ML models may be trained with historical case data from an unstructured case management model. The plurality of ML models may generate recommendations when presented with current case data. The recommendations may be utilized to automatically activate the manually activated plan items when the confidence score is above a predefined threshold. Advantages of these techniques include reducing human error and fatigue as fewer decisions need to be made by humans.

### BACKGROUND

Unless otherwise indicated herein, the approaches described in this section are not prior art to the claims in this application and are not admitted to be prior art by inclusion in this section.

Case Management Model and Notation (CMMN) is an event driven system that allows for modeling processes driven by specific events, making it ideal for scenarios with dynamic elements like customer inquiries or regulatory changes. In unstructured processes often encountered in healthcare, legal, and customer service, CMMN can provide a flexible framework for capturing the inherent variability and is perfect for diverse business environments. However, manual human intervention is often required to determine whether a plan item in the event driven system should be activated. This human interaction can be error prone due to human mistakes when faced with complex decision-making and human exhaustion. Thus, there is a need for an improved technique for activating plan items.

### BRIEF DESCRIPTION OF THE DRAWINGS

FIG. 1 illustrates a system for generating recommendations for manually activated plan items according to some embodiments.

FIG. 2 illustrates a case plan according to some embodiments.

FIG. 3 illustrates an exemplary system for generating recommendations for manually activated plan item according to some embodiments.

FIG. 4 illustrates an exemplary workflow for training a ML model according to some embodiments.

FIG. 5 depicts a simplified block diagram of an example computer system, which can be used to implement some of the techniques described in the foregoing disclosure.

### DETAILED DESCRIPTION

Described herein are methods and apparatuses to generate recommendations for plan items that are configured for manual activation. Sentries are conditions attached to a plan item, such as events, tasks, or stages within a case plan, which are evaluated to decide the potential execution (entry sentries) or termination (exit sentries) of an associated plan item. The CMMN specification outlines various ways in which sentries can be defined. In one example, a sentry can utilize condition expressions, which are Boolean expressions defined in the CMMN specification. These expressions are evaluated to determine whether the associated plan item should be activated or completed. The condition expression can involve variables of the context of the running case. In another example, a sentry can be dependent on the occurrence of events. If an event that a sentry is waiting for occurs, the associated plan item is activated. By utilizing these activation mechanisms. CMMN provides a powerful and flexible way to model and manage cases, enabling adaptive and event-driven case management capable of capturing the nuances of complex and dynamic business processes.

In general when a sentry on a plan item is satisfied, the plan item's state changes from “available” to “active.” However, if manual intervention is needed by the end user to activate a plan item, then a manual activate rule can be configured on the plan item. This mechanism provides flexibility in case management, where certain conditions may require human judgment or intervention to determine whether a plan item should be activated. The solutions described herein include leveraging machine learning (ML) models to provide recommendations as to whether a plan item should be manually activated by the end user. In one embodiment, the plan item may be automatically activated when the confidence score in the recommendation is above a predefined threshold such as 95%. In another embodiment, the end user may be presented with the confidence score as a data point in deciding whether to activate the plan item. In yet another embodiment, the plan item may be automatically activated when the confidence score is above a predefined threshold and a query can be generated asking the end use if he or she wishes to activate the plan item when the confidence score is at or below the predefined threshold. One advantage to providing the recommendation includes reducing the dependency on human expertise. If the end user lacks the necessary knowledge or expertise to decide, there is a risk of misjudging conditions and improperly activating or not activating plan item when needed. Another advantage of providing the recommendation includes reducing errors made in complex scenarios. In scenarios with complex conditions or numerous parameters to consider, manual activation may become intricate and end users who navigate through various factors which may potentially lead to decision fatigue or oversight of critical conditions. In some embodiments, backend runtime can calculate the confidence level for a plan item which is configured for manual activation and give flexibility to the developer to define condition(s) stored either on the sentry or the plan item.

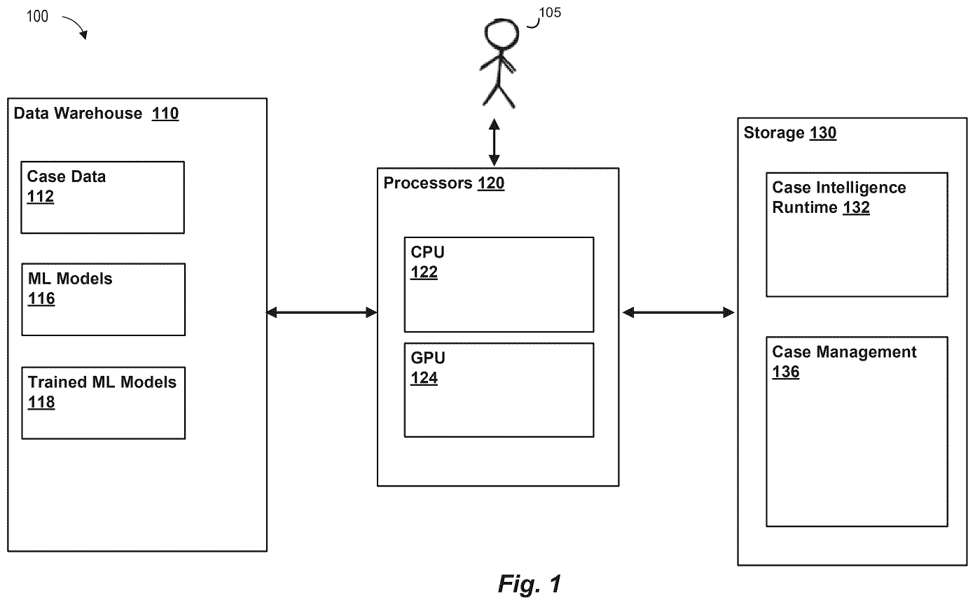

FIG. 1 illustrates a system for generating recommendations for manually activated plan items according to some embodiments. System 100 includes user 105, data warehouse 110, processors 120, and storage 130. Processors 120, which include CPU 122 and GPU 124 are configured to process computer readable instructions from storage 130 to process data and ML models from data warehouse 110. Data warehouse 110 includes case data 112, ML models 116, and trained ML models 118. Case data 112 includes data generated during case execution. This can include event logs, input/output context, and system state information. Event logs include date and time of each user interaction to help in understanding the temporal aspects of user behavior. An example event can include manually activating a plan item. An exemplary event is shown below:

```
Key: Log/<unique generated UUID>
//** HEADERS **
tenant = 086e698b-247b-4725-b35f-7c8748a5dcaa
user-id = john.doe@sap.com
“type” = “run.logstep.v1”
/** possible values for ″case-event-type″ could be: STEP_MANUAL_ENABLED or
STEP_MANUAL_ACTIVATED or STEP_MANUAL_DISABLED
There could be scenario where user does not want to activate some step manually. In that case, user can take an
action on step to disable it. For such action, Case Runtime will emit “STEP_MANUAL_DISABLED” event
type.**/
″case-event-type″= ″STEP_MANUAL_ACTIVATED”,
″case-step-definition-id″= ″step1″,
″case-definition-id″= ″networkConnectivityDiagnosisCase ″,
″project-id″= ″ project1″,
{
  // ** MESSAGE PROPERTIES **
  ″runGroupId″: ″5737029d-97db-4f7a-a6f6-d126f5598911″,
  ″self″: {
      ″id″: ″caseInstanceId″, //This is case instance id
      ″stepId″: ″stepInstanceId″, //This is step instance id
      ″name″: ″Network Configuration Check″
  },
  ″source″: {
      ″type″: ″trigger.api|trigger.event|trigger.scheduler| Or any other source which started the
case″,
      ″id″: ″triggerInstanceId″,
  },
  ″timestamp″:″2024-05-01T13:33:12.929Z″,
  ″case″: {
    ″eventType″: ″ STEP_MANUAL_ACTIVATED ″, //There could be other events also here as
mentioned above
    ″definitionId″: ″ networkConnectivityDiagnosisCase ″,
    ″userId″: ″userWhoStartedCase″,
    ″step”: {
        ″definitionId″: ″networkconfigurationcheck ″,
        ″name″: ″Network Configuration Check ″,
        ″instanceId″: ″stepInstanceId″
    }
  },
  “input”: {
/** Event Data when a step was enabled or manually activated or disabled. This data or most relevant subset of
this data will be used for ML training. When step is enabled, this data will be used to calculate the confidence
level by case intelligence runtime **/
        “attributeId1”: “value1”,
        “attributeId2”: “value2”,
        “attributeId3”: “value3”,
        “attributeId4”: “value4”,
        “attributeId5”: “value5”,
  }
}
```

Input/output context includes relevant details (and identify any recurring pattern) on current state and any specific conditions that might have resulted in particular user behavior. System state includes external conditions (e.g. warranty is valid), events or real time alerts that could have impact, such as system outages, delays, or critical alerts etc. ML models 116 contain ML models that can be trained on case data 112 to create trained ML models. The trained ML models can be stored in trained ML models 118. The training can include providing the ML model historical case data as input variables and expected output variables (ground truth). Trained ML models 118 can be configured to receive case data on the current state of the case plan and generate a recommendation as to whether a plan item should be manually activated. In one embodiment, a recommendation system may provide APIs to generate recommendations based on the current state of the case data at case intelligence runtime.

Storage 130 stores computer readable instructions which, when executed by one or more processors in processors 120, can manage a case plan. The computer readable instructions can include case management 136 and case intelligence runtime 132. Case management 136 is configured to manage a case plan, which can include managing the execution of the plan items within the case plan. Case intelligence runtime 132 is configured to train ML models using case data collected during runtime. Case intelligence runtime 132 is also configured to utilize the trained ML models to generate recommendations as to whether manually activated plan item should be activated.

Here, user 105 who is monitoring the runtime of the case plan may be presented a question on a user interface to decide whether to manually activate a plan item in the case plan. User 105 may optionally request a recommendation on whether the plan item should be activated. In one example, the recommendation may be requested from, and received by case intelligence runtime 132. Once the recommendation is received, user 105 can use the recommendation as one data point in deciding whether to activate the plan item. In yet other examples, the recommendation may be automatically generated whenever a plan item with a manual activation rule is available. The recommendation may in turn be used to automatically activate the manually activated plan item when the confidence score in the recommendation is above a predefined threshold. The recommendation may also be used to determine when to present the question whether to activate the plan item. For instance, a recommendation with a confidence score about a first threshold such as at or above 90% may be automatically approved by the system. But if the confidence score is below 90%, then the system should present the question to user 105 to make a determination whether to activate the plan item. Similarly, if the confidence score is below a second threshold such as below 50%, then the system may automatically deny activation of the plan item or disable the plan item. These use cases may be advantageous since user 105 has a simple recommendation to review rather than complex case data and some plan item activations may occur automatically, thus reducing the time spent by user 105 in reviewing plan item activation decisions.

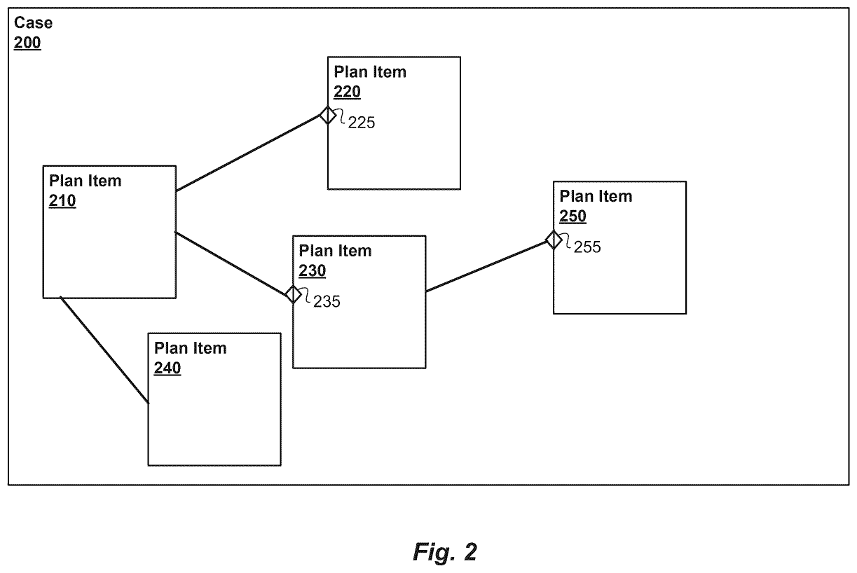

FIG. 2 illustrates a case plan according to some embodiments. Case plan 200 includes plan items 210, 220, 230, 240, and 250. Each plan item may be associated with a task that can be performed on the case. As shown, plan item 220 includes sentry 225. Sentry 225 can be a rule or condition attached to the plan item 220 that when satisfied, activates the plan item. The condition can be a Boolean expression or any other form of expression. In some examples, the condition may require a manual activation through human interaction. As shown, plan item 230 includes sentry 235 and plan item 250 includes sentry 255. Plan 30) item 240) does not include a sentry and thus will be executed following plan item 210. Case plan 200 may begin with the execution of plan item 210. Then based on whether sentries 225 and 235 are satisfied, case plan 200 may continue at the completion of plan item 210 to either plan item 220, 230, or 240.

A concrete example will now be provided. A case context may be a customer reporting difficulty connecting a new smart device to their home network and case plan 200 describes how to address the customer's issue. The case plan can include tasks (i.e. plan items) like “Initial Assessment.” “Network Configuration Check.” “Device Compatibility Review:” and “Resolution Steps.” Some plan items may be configured with manual activation rules meaning that manual activation is required. When manual activation is required, a technical support representative, upon receiving the case, reviews initial information before activating tasks. A decision whether to manually activate the task is based on structured data, including error logs from the customer's device, network configuration details, device compatibility database, and historical data on similar issues. With “Initial Assessment,” the representative examines error logs provided by the customer to identify specific issues with the device's attempts to connect to the network. With “Network Configuration Check.” the representative analyzes the customer's network configuration detail and assesses whether there are any misconfigurations affecting connectivity. With “Device Compatibility Review:” the representative consults a device compatibility database to check if the customer's device is compatible with the network specifications. With “Historical Data Analysis,” the representative reviews historical data on similar issues and determines if there are recurring patterns or known solutions. Advantages of the solutions described herein is that the manual process of having a technical support representative manually analyze the case plan and manually activate plan items when appropriate can be simplified. In some embodiments, a recommendation as to whether to activate a manually activated plan item can be provided in the form of a confidence score. The confidence score can be generated by one or more ML models trained on historical case data. When there are more than one ML models, the scores generated from the ML models may be weighted and combined. Depending on the implementation details, the recommendation can be used to automatically activate plan items that are configured for manual activation. In one embodiment, a manual activation rule condition such as “manualActivationRule”: “{steps.stepId1.last.confidenceLevel >0.95}” can be configured while modelling the case plan in design time. Therefore, the rule condition resides on the case plan. In another embodiment, the manual activation rule condition is not defined on the plan item but instead is defined on the sentry. For example, the sentry may have the rule condition: “$ {steps.stepId1.last.confidenceLevel >0.95}”. When the condition on the sentry is satisfied, the corresponding plan item may automatically be activated. Please note that here the plan item need not to be configured with manual activation rule. Alternatively, the recommendation can be provided to the technical support representative as guidance on whether to activate the plan item.

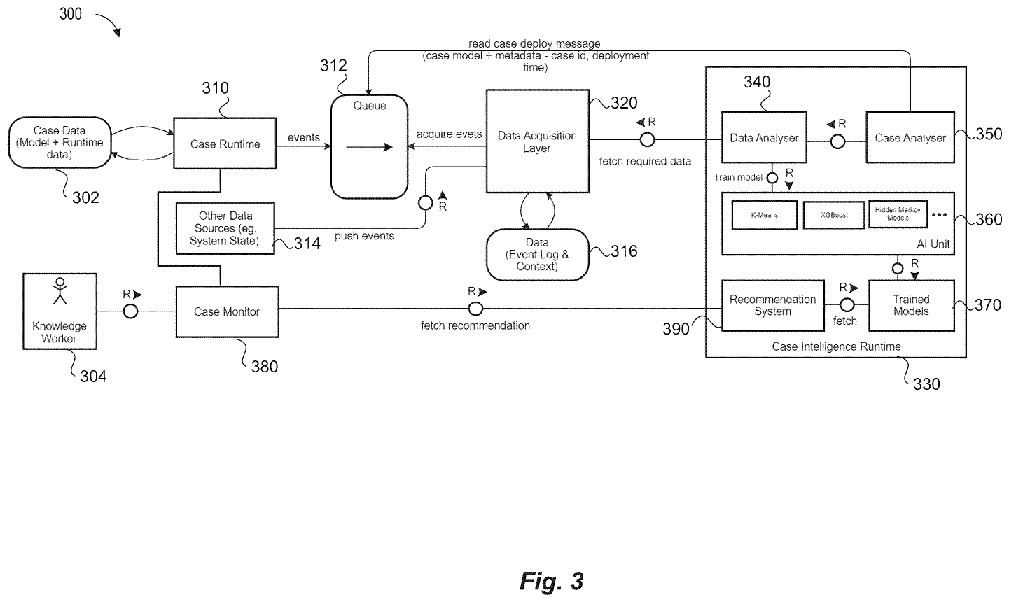

FIG. 3 illustrates an exemplary system for generating recommendations for manually activated plan item according to some embodiments. System 300 is capable of training ML models and also using trained ML models to provide a recommendation. System 300 includes case runtime 310 which is the runtime environment for the case plan. Case runtime 310 is in communication with case data 302 which stores data generated during case execution. Case data 302 may also pass back runtime data or the case model when requested by case runtime 310. During runtime, case runtime 310 may generate events which enter queue 312. Queue 312 may store events generated during runtime. Queue 312 can be any platform which supports streaming data or events. In one example, the platform may be Kakfa which can be used to capture all of the events coming from case runtime. Advantages of using such a platform include providing low latency and high throughput. The events may be generated for any transaction happing in case runtime. For example, an event may be the start of a plan item such as initial assessment or the completion of said plan item. An example of a case model is included below:

```
{
  “a6cb44f4-b236-4efa-a948-934ee0dac571”: {
    “classDefinition”: “com.sap.bpm.case.Model”,
    “id”: “networkConnectivityDiagnosisCase ” ,
    “name”: “Network Connectivity Diagnosis Case ”,
    “projectId”: “ project1”,
    “projectVersion”: “1.0.0”,
    “artifactId”: “3382dc1e-594d-486b-a63c-7f63f222c52b”,
    “documentation”: “Case to diagnose and resolve a Network Connectivity Issue”,
    “steps”: {
      “15a9b5ee-17c0-4159-9bbf-454dcfdcd5c3”: {
        “name”: “Initial Assessment”
      },
      “16a9b5ee-17c0-4159-9bbf-454dcfdcd5c3”: {
        “name”: “Network Configuration Check”
      }
    },
    “15a9b5ee-17c0-4159-9bbf-454dcfdcd5c3”: {
      “classDefinition”: “com.sap.bpm.case.Step”,
      “id”: “initialassessment”,
      “name”: “Initial Assessment”,
      “documentation”: “A Step which is required to do the initial assessment”,
      “isRequired”: true,
      “definitionRef”: “h2e0c701-973b-4ebe-a4f9-c4784634608e”
    },
    “16a9b5ee-17c0-4159-9bbf-454dcfdcd5c3”: {
      “classDefinition”: “com.sap.bpm.case.Step”,
      “id”: “networkconfigurationcheck”,
      “name”: “Network Configuration Check”,
      “documentation”: “A Step to check the network configuration”,
      “criteria”: {
        “c6cb44f4-b236-4efa-a948-934ee0dac571”: { }
      },
      “manualActivationRule”: “${steps.step1.last.confidenceLevel < 0.95}”,
      “definitionRef”: “k3e0c701-973b-4ebe-a4f9-c4784634608f”
    },
    “c6cb44f4-b236-4efa-a948-934ee0dac571”: {
      “classDefinition”: “com.sap.bpm.case.EntryCriterion”,
      “sentryRef”: “sentry-B6A9C9C0-D88B-49D2-84A9-A155F060B848”
    },
    “sentry-B6A9C9C0-D88B-49D2-84A9-A155F060B848”: {
      “classDefinition”: “com.sap.bpm.case.Sentry”,
      “condition”: “”,
      “transitionEvents”: {
        “event1cb44f4-b236-4efa-a948-934ee0dac572”: { }
      }
    },
    “event1cb44f4-b236-4efa-a948-934ee0dac572”: {
      “classDefinition”: “com.sap.bpm.case.TransitionEvent”,
      “sourceRef”: “15a9b5ee-17c0-4159-9bbf-454dcfdcd5c3”,
      “type”: “complete”
    },
    “h2e0c701-973b-4ebe-a4f9-c4784634608e”: {
      “classDefinition”: “com.sap.bpm.case.HumanTask”,
      “recipientsUsers”: {
        “value”: “[info.startedBy]”,
        “type”: “formula”,
        “version”: “1”
      }
    },
    “k3e0c701-973b-4ebe-a4f9-c4784634608f”: {
      “classDefinition”: “com.sap.bpm.case.HumanTask”,
      “recipientsUsers”: {
        “value”: “[info.startedBy]”,
        “type”: “formula”,
        “version”: “1”
      }
    }
  }
}
```

System 300 further includes case intelligence runtime 330. Case intelligence runtime 330 is configured to analyze case data along with other data associated with the case for purposes of training one or more ML models. The ML models would be trained to generate recommendations as to whether to activate a manually activated configured plan item given the current context of the case. Case intelligence runtime 330 includes data analyzer 340 and case analyzer 350. Case analyzer 350 may first analyze the deployed case to determine what data should be requested from data analyzer 340. In one embodiment, case analyzer 350 may query queue 312 to read case deploy messages generated from case runtime and analyze relevant metadata of the plan items corresponding to the case. Based on the analysis, case analyzer 350 may submit a request to data analyzer 340 to fetch corresponding runtime data and event information from data acquisition layer 320 that will be used to train the models. Case analyzer 350 may read case deploy messages from queue 312 specifying parameters such as the case model, metadata, case ID, and when the case was deployed (i.e., deployment time). With such parameters in consideration, case analyzer 350 may generate a data and event request to data analyzer 340, which in turn retrieves the requested information. Data acquisition layer 320 collects relevant data from various sources for analysis. The relevant data can include data that should be considered when deciding whether to activate a particular manually activated plan item. Here, data acquisition layer 320 collects events from queue 312, events from other data sources 314, and also data 316 which can include event logs and context. Data acquisition layer 320 may store all the information acquired from queue 312, other data sources 314, and data 316. Below is an example of data acquired from the data acquisition layer that is used for training the machine learning models. Each row in this table belongs to the “Input” data of the event (of type=“STEP_MANUAL_ACTIVATED” or “STEP_MANUAL_DISABLED). Values of manual activation can be either 1 or 0. Value 1 indicates that a step was manually activated. Value 0 indicates that step was disabled by user.

| attributeId1 | attributeId2 | attributeId3 | attributeId4 | attributeId5 | manualActivation |
|---|---|---|---|---|---|
| V1 | V2 | V3 | V4 | V5 | 1 |
| V11 | V22 | V33 | V44 | V55 | 0 |
| V111 | V222 | V333 | V444 | V555 | 1 |
| V1111 | V2222 | V3333 | V4444 | V5555 | 0 |

Data analyzer 340 fetches the data from data acquisition layer 320. Data analyzer 340 may in turn use the fetched data to train ML models in AI unit 360. As shown here, AI unit 360 includes 3 ML models-K-means, XGBoost, and Hidden Markov models however different implementations can include different ML models or different number of ML models. Training the ML models can include providing input variables along with expected output variables (i.e., ground truth) to train the parameters within the ML model. Once trained, AI unit 360 stores the trained ML models in trained models 370.

System 300 also includes knowledge worker 304. Knowledge worker 304's role in system 300 is to monitor the case during runtime and provide human interaction when required. For example, knowledge worker 304 may analyze manually activated plan items when they are enabled or available and manually activate the plan items based on the analysis. Knowledge worker 304 may monitor the case through case monitor 380, which is in communication with case runtime 310. Case monitor 380 may retrieve data from case runtime 310 to present the current status of the case. Case monitor 380 may also transmit instructions such as activation of a manual plan item to case runtime 310. When a decision is to be made as to whether to activate a manual plan item, knowledge worker 304 may transmit a fetch recommendation request through case monitor 380 to recommendation system 390. The recommendation request can include current case data that describes the current state of the case in case runtime 310. Recommendation system 390 is within case intelligence runtime and is configured to provide a recommendation on whether to activate a manually activated plan item. Recommendation system 390 may fetch trained ML models from trained models 370, provide input variables to the trained models and retrieve the output from the models. The output from the ML models is a confidence score indicating the likelihood that the manually activated plan item should be activated. In other embodiments, case monitor 380 may automatically fetch recommendations from recommendation system 390 when it is determined that a decision needs to be made on a manually activated plan item in case runtime 380). For example, case runtime 310 may transmit a request to case monitor 380 for a decision on a manually activated plan item and the request may automatically trigger the fetch recommendation to recommendation system 390. The request from case runtime 380) can include metadata that is subsequently used as the input variables for trained ML models to generate a recommendation. As another example, recommendations can be automatically generated when a manually activated plan item event is available in case runtime. Case runtime 310 may listen for any manually activated plan item events that are available. Once a manually activated plan item event is available, case runtime 310 can transmit a fetch recommendation to case intelligence runtime 330 and receive a confidence score in response. The fetch recommendation may include the input variables associated with submitting a query to trained models 370. This way, case runtime can proactively generate confidence scores for manually activated plan item events so that the confidence score is available to either be used to automatically activate a plan item or to be provided to a knowledge worker as useful information when deciding whether to manually activate the plan item.

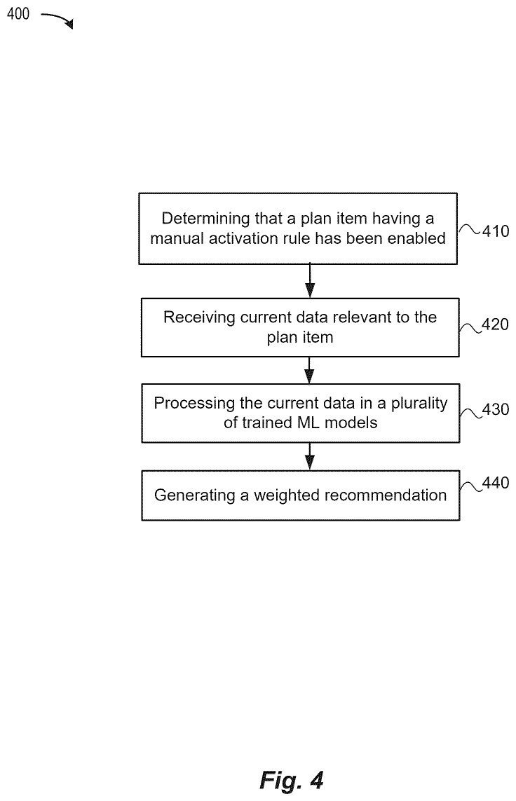

FIG. 4 illustrates an exemplary workflow for training a ML model according to some embodiments. Workflow 400 can be implemented as computer readable code executable by one or more processors from processors 120 of FIG. 1. Workflow 400 can begin by determining that a plan item having a manual activation rule in an unstructured case management model has been enabled. In one embodiment, the determination may be made by receiving a notification from a runtime environment that a decision is to be made for a plan item having manual activation rule. This can occur as the state of the case management model is about to start with a new plan item. In another embodiment, the determination may be made by analyzing current data in the case management model to determine that a plan item configured with the manual activation rule has been enabled. Workflow 400 can then continue by receiving current data relevant to the plan item at 420. The current data can include event logs, input/output context, and system state information. The current data may be received from the runtime environment. In other embodiments, current data can be data relevant to the plan item that is associated with the sentry. Workflow 400 can then continue by processing the current data in a plurality of trained ML models at 430. The current data may be provided as input variables to the plurality of trained ML models and the output of the trained ML models may be a confidence score. The higher the confidence score, the more likely the trained ML model is recommending activating the plan item. Exemplary ML models that can be used include extreme gradient boosting (XGBoost). K-means. Markov. and Hidden Markov. Workflow 400 can continue by generating a weighted recommendation from the plurality of recommendations at 440, where the plurality of recommendations was generated by the plurality of trained ML models. The weighted recommendation may be utilized for many purposes. For example, the system may automatically activate the plan item when the weighted recommendation is above a predefined threshold. As another example, the system may present the weighted recommendation to a user to help guide the user on making a decision whether to manually activate the plan item configured with the manual activation rule. The user may be a human with privileges to manually activate the plan item. As another example, the system may present the weighted recommendation to the user and ask whether the user wishes to manually activate the plan item when the weighted recommendation is below a predefined threshold. When above the predefined threshold, the system may automatically activate the plan item. Once the weighted recommendation has been generated, the current data used to generate the recommendation, generated recommendation, and the user action (if any) may be used to retrain the plurality of ML models, thus allowing the ML models to continuously improve with newly available data. A description of the ML models mentioned above will follow.

XGBoost (eXtreme Gradient Boosting)

XGBoost is a powerful and efficient machine learning algorithm. It belongs to the family of gradient boosting algorithms, which iteratively builds a strong predictive model by combining the outputs of weak learners (typically decision trees). XGBoost builds an ensemble of decision trees sequentially, with each tree correcting errors made by the previous ones, thereby boosting the gradients. In one embodiment, the context data collected during previous runs can be used for training the model. XGBoost includes a built-in mechanism to measure feature importance. It calculates the contribution of each feature to the model's predictions based on the given input features.

In XGBoost, the model is trained using historical case data. Continuing with the concrete example above, features such as error logs, error logs frequency, symptoms reported by the customer, network configuration, and device compatibility can be used to train the model. During model execution, a feature vector is provided as input variable and a confidence score is generated by the model. An exemplary current case feature vector is feature_vector={‘error_log_frequency’: high, ‘error_type’: ‘Network Timeout’, ‘hidden_SSID’: True, ‘DHCP_enabled’: True, ‘device_compatibility’: True}. An exemplary confidence score generated can be 0.94 which means 94% confidence to manually activate the plan item.

### K-Means Clustering

K-Means Clustering is an unsupervised machine learning algorithm used for partitioning a dataset into K distinct, non-overlapping subsets or clusters. The algorithm aims to group similar data points together, where the similarity is defined based on the features of the data. This allows K-Means clustering to identify patterns or groups of cases that share similar characteristics. In one embodiment, features of the data can be extracted from the event logs, context and system state. For example, the features may comprise of number of system logs, user feedbacks, external factors etc. or the content or qualitative aspects of system logs, user feedback etc. provided as vectorized text. The K-Mean Clustering model may analyze the features and group them into ‘K’ different clusters based on commonalities. Each cluster may represent a certain type or pattern of scenarios leading to certain behavior. For example, with K=3 clusters, the K-Means algorithm could group similar cases into three clusters. Cluster interpretation might reveal the following:
Cluster 1: Cases with high user feedback, moderate system logs.
Cluster 2: Cases with diverse system logs, low user feedback, and varied external factors.
Cluster 3: Cases with specific external factors, and moderate user feedback.

An example features for clustering vector that is used as an input variable for the model is features_for_clustering=[high_error_log_frequency, ‘Network Timeout’, True, #hidden SSID True, #DHCP_enabled True, #device_compatibility True]. The output from the model can be an assignment to one of the clusters with a confidence score. For example, the model may generate an output such as similar cluster 3 issues are resolved with an 87% success rate with the next step as “Network Configuration Check.”

### Markov Models

Markov Models are probabilistic models that represent systems with a set of states, and the probability of transitioning between these states over time. Markov Models follow the Markov property, which states that the future state of the system depends only on its current state and not on the sequence of events that preceded it. The Key Components of Markov Models are:
i) States(S): Represent different situations or conditions in the system. States can be observable (visible) or hidden.
ii) Transitions (A): Describe the probabilities of moving from one state to another. The transition probabilities are often represented in a transition matrix (A).
iii) Observations (B): Specify the probabilities of observing certain outcomes (emissions) given the current state. The emission probabilities are often represented in an emission matrix (B). Observations and States will be same, if states are not hidden.
iv) Initial State Probabilities (x): Represent the probabilities of starting in each state.

### Hidden Markov Models

Hidden Markov Models are Markov models in which states are not directly observable. The model itself assumes that there is a sequence of hidden states that generate the observed data. The system emits observations, and the goal is to infer the sequence of hidden states that best explains the observed data. Hidden Markov Models works as following:
i) Initialization: Set initial state probabilities, transition probabilities, and emission probabilities. These are done by an expert based on domain knowledge or prior experiences.
ii) Forward Algorithm: Calculate the probability of observing a sequence of data points given the model.
iii) Backward Algorithm: Calculate the probability of transitioning from each state to the end of the sequence given the model.
iv) Expectation-Maximization (EM): Use the forward and backward probabilities to update the model parameters (transition and emission probabilities).
v) Viterbi Algorithm: Find the most likely sequence of hidden states that explains the observed data.

For example, consider the following four hidden states representing different stages of troubleshooting. S is a vector representing the current hidden state. Each element corresponds to a stage in the troubleshooting process.
1) S1: Initial Assessment
2) S2: Network Configuration Check
3) S3: Device Compatibility Review
4) S4: Resolution Steps

Observations (O): Observable events or progress indicators during troubleshooting. The progress indicators may be observed data points or sequence of events. O is a vector representing observable events or progress indicators during troubleshooting. For example, the observations can include logs and network configuration details. In one embodiment, the O vector influences the computation of emission probabilities-which describe the likelihood of observing specific data points given the current hidden state. These emission probabilities are incorporated into the forward and backward algorithms during the calculation of probabilities. The forward algorithm calculates the probability of observing a sequence of data points or symbols given the model parameters, including the initial state probabilities, transition probabilities, and emission probabilities. The backward algorithm calculated the probability of transitioning from each state to the end of the sequence given the model parameters and observed data.

Transition Probabilities (A): A is a matrix indicating the probabilities of transitioning between hidden states. The matrix may be based on historical data. Rows represent the current state, and columns represent the next state. For example, A[1] [2] is 0.1, indicating a 10% probability of transitioning from S1 to S2.

$$A = [ \begin{matrix}0.7 & 0.1 & 0.1 & 0.1 \\ 0.2 & 0.6 & 0.1 & 0.1 \\ 0.1 & 0.2 & 0.5 & 0.2 \\ 0.1 & 0.1 & 0.2 & 0.6\end{matrix} ]$$

Initial State Probabilities (π): π is a vector representing the initial probabilities of starting in each hidden state. The vector is also based on historical data. For example, π[1] is 0.5, indicating a 50% probability of starting in S1.

$$π = [ \begin{matrix}0.5 \\ 0.3 \\ 0.1 \\ 0.1\end{matrix} ]$$

1) Initialization: First, the system may initialize by reading the initial state probabilities (π)=[0.25, 0.25, 0.25, 0.25]. The initial state probabilities define the likelihood of starting in the various states.

2) Forward Algorithm: Next, the system may use the forward algorithm to calculate probabilities of observing sequences. For example, forward_prob=calculate_forward_probabilities (observations, transition_matrix, emission_matrix).

3) Backward Algorithm: Next, the system may use the backward algorithm to calculate the probabilities of transitioning to the sequence end. For example, backward_prob=calculate_backward_probabilities (observations, transition_matrix, emission_matrix).

4) Expectation-Maximation (EM): Next, the system updates the model parameters. For example, transition_matrix, emission_matrix=update_parameters (forward_prob, backward_prob, observations).

5) Viterbi Algorithm: Next, the system uses the Viterbi algorithm to find the most likely sequence of hidden states given the observed events or symbols. While the Viterbi algorithm itself does not inherently provide a confidence score for the predicted next state, it does yield the likelihood of the entire predicted state path. For example, sequence_probability=viterbi_algorithm (observations, transition_matrix, emission_matrix).

6) Generating Output: Next, the system computes a confidence score for transitioning to a given state. The confidence score may be based on one or more of the following factors:
a) Viterbi algorithm output that describes the most likely sequence of hidden states, which includes the transition from S1 to S2.
b) Transition probability which is the matrix table based on historical data that describes the likelihood of transitioning to another state. Once the Viterbi algorithm provides the most likely sequence of transition from S1 to S2, the transition probability table can be utilized to identify the likelihood of transitioning to that state based on historical data. Based on the matrix above, the likelihood of transitioning from S1 to S2 can be 10%.
c) Observation likelihood measures the likelihood of observing the associated symbols (error logs, network configuration details) given the predicted state S2 contributes to the confidence score.
d) Normalization takes place by combining one or more of the above probabilities and/or factors and ensures that the confidence score is within the range of 0 and 1 and then normalizing the combined score to obtain a comprehensive confidence score. For example, a score of 0.96, or 96% confidence in transitioning from S1 to S2 “Network Configuration Check.”

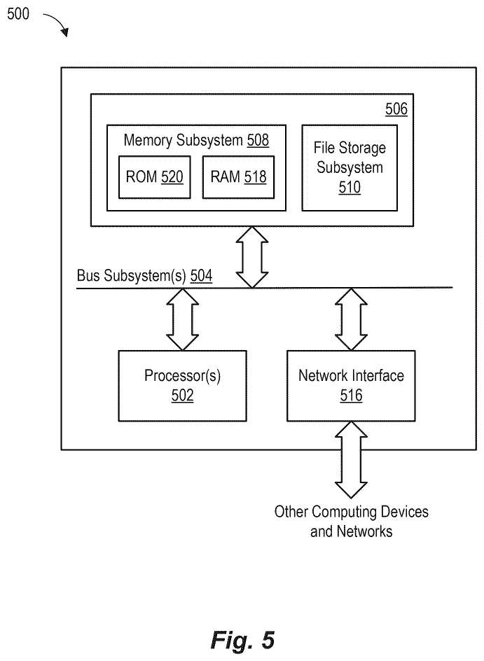

FIG. 5 depicts a simplified block diagram of an example computer system, which can be used to implement some of the techniques described in the foregoing disclosure. As shown in FIG. 5, system 500 includes one or more processors 502 that communicate with several devices via one or more bus subsystems 504. These devices may include a storage subsystem 506 (e.g., comprising a memory subsystem 508 and a file storage subsystem 510) and a network interface subsystem 516. Some systems may further include user interface input devices and/or user interface output devices (not shown).

Bus subsystem 504 can provide a mechanism for letting the various components and subsystems of system 500 communicate with each other as intended. Although bus subsystem 504 is shown schematically as a single bus, alternative embodiments of the bus subsystem can utilize multiple buses.

Network interface subsystem 516 can serve as an interface for communicating data between system 500 and other computer systems or networks. Embodiments of network interface subsystem 516 can include, e.g., Ethernet, a Wi-Fi and/or cellular adapter, a modem (telephone, satellite, cable, etc.), and/or the like.

Storage subsystem 506 includes a memory subsystem 508 and a file/disk storage subsystem 510. Subsystems 508 and 510 as well as other memories described herein are examples of non-transitory computer-readable storage media that can store executable program code and/or data that provide the functionality of embodiments of the present disclosure.

Memory subsystem 508 comprise one or more memories including a main random access memory (RAM) 518 for storage of instructions and data during program execution and a read-only memory (ROM) 520 in which fixed instructions are stored. File storage subsystem 510 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that system 500 is illustrative and many other configurations having more or fewer components than system 500 are possible.

The above description illustrates various embodiments of the present invention along with examples of how aspects of the present invention may be implemented. The above examples and embodiments should not be deemed to be the only embodiments and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

### FURTHER EXAMPLES

Each of the following non-limiting features in the following examples may stand on its own or may be combined in various permutations or combinations with one or more of the other features in the examples below. In various embodiments, the present disclosure may be implemented as a processor or method.

In some embodiments the present disclosure includes a method, comprising: determining that a plan item in an unstructured case management model has been enabled, the plan item configured for manual activation, receiving current data relevant to the plan item from the unstructured case management model, processing the current data in a plurality of trained machine learning (ML) models, wherein each trained ML model generates a recommendation, and generating a weighted recommendation based on the plurality of recommendations, wherein the weighted recommendation represents a confidence level that the plan item should be activated.

In one embodiment, the method further includes activating the plan item when the weighted recommendation is above a predefined threshold.

In one embodiment, the method further includes presenting a request to manually activate the plan item when the weighted recommendation is at or below the predefined threshold.

In one embodiment, the method further includes presenting the weighted recommendation to a user having privileges to manually activate the plan item.

In one embodiment, the trained ML models have been trained with historical case data from the unstructured case management model.

In one embodiment, the current data includes at least one of event logs, input/output context, and system state information.

In one embodiment, the current data is received from a runtime environment of the unstructured case management model.

In one embodiment, the method further includes retraining the plurality of trained ML models with at least the current data received from the runtime environment.

In some embodiments, a system comprises one or more processors: a non-transitory computer-readable medium storing a program executable by the one or more processors, the program comprising sets of instructions for: determining that a plan item in an unstructured case management model has been enabled, the plan item configured for manual activation, receiving current data relevant to the plan item from the unstructured case management model, processing the current data in a plurality of trained machine learning (ML) models, wherein each trained ML model generates a recommendation, and generating a weighted recommendation based on the plurality of recommendations, wherein the weighted recommendation represents a confidence level that the plan item should be activated.

In some embodiments, a non-transitory computer-readable medium stores a program executable by one or more processors, the program comprising sets of instructions for determining that a plan item in an unstructured case management model has been enabled, the plan item configured for manual activation, receiving current data relevant to the plan item from the unstructured case management model, processing the current data in a plurality of trained machine learning (ML) models, wherein each trained ML model generates a recommendation, and generating a weighted recommendation based on the plurality of recommendations, wherein the weighted recommendation represents a confidence level that the plan item should be activated.

What is claimed is:

1. A method, comprising:
determining that a plan item in an unstructured case management model has been enabled, the plan item configured for manual activation;
receiving current data relevant to the plan item from the unstructured case management model:
processing the current data in a plurality of trained machine learning (ML) models, wherein each trained ML model generates a recommendation; and
generating a weighted recommendation based on the plurality of recommendations, wherein the weighted recommendation represents a confidence level that the plan item should be activated.

2. The method as in claim 1, further comprising activating the plan item when the weighted recommendation is above a predefined threshold.

3. The method as in claim 2, further comprising presenting a request to manually activate the plan item when the weighted recommendation is at or below the predefined threshold.

4. The method as in claim 1, further comprising presenting the weighted recommendation to a user having privileges to manually activate the plan item.

5. The method as in claim 1, wherein the trained ML models have been trained with historical case data from the unstructured case management model.

6. The method as in claim 1, wherein the current data includes at least one of event logs, input/output context, and system state information.

7. The method as in claim 6, wherein the current data is received from a runtime environment of the unstructured case management model.

8. The method as in claim 7, further comprising retraining the plurality of trained ML models with at least the current data received from the runtime environment.

9. A system comprising:
one or more processors:
a non-transitory computer-readable medium storing a program executable by the one or more processors, the program comprising sets of instructions for:
determining that a plan item in an unstructured case management model has been enabled, the plan item configured for manual activation:
receiving current data relevant to the plan item from the unstructured case management model:
processing the current data in a plurality of trained machine learning (ML) models, wherein each trained ML model generates a recommendation; and
generating a weighted recommendation based on the plurality of recommendations, wherein the weighted recommendation represents a confidence level that the plan item should be activated.

10. The system of claim 9, further comprising activating the plan item when the weighted recommendation is above a predefined threshold.

11. The system of claim 10, further comprising presenting a request to manually activate the plan item when the weighted recommendation is at or below the predefined threshold.

12. The system of claim 9, wherein the trained ML models have been trained with historical case data from the unstructured case management model.

13. The system of claim 9, wherein the current data includes at least one of event logs, input/output context, and system state information.

14. The system of claim 13, wherein the current data is received from a runtime environment of the unstructured case management model.

15. A non-transitory computer-readable medium storing a program executable by one or more processors, the program comprising sets of instructions for:
determining that a plan item in an unstructured case management model has been enabled, the plan item configured for manual activation:
receiving current data relevant to the plan item from the unstructured case management model:
processing the current data in a plurality of trained machine learning (ML) models, wherein each trained ML model generates a recommendation; and
generating a weighted recommendation based on the plurality of recommendations, wherein the weighted recommendation represents a confidence level that the plan item should be activated.

16. The non-transitory computer-readable medium of claim 15, wherein determining that the training dataset has one or more additional deterministic relations not yet captured by the first machine learning model comprises:
further comprising activating the plan item when the weighted recommendation is above a predefined threshold.

17. The non-transitory computer-readable medium of claim 16, further comprising presenting a request to manually activate the plan item when the weighted recommendation is at or below the predefined threshold.

18. The non-transitory computer-readable medium of claim 16, further comprising presenting the weighted recommendation to a user having privileges to manually activate the plan item.

19. The non-transitory computer-readable medium of claim 16 wherein the trained ML models have been trained with historical case data from the unstructured case management model.

20. The non-transitory computer-readable medium of claim 16, wherein the current data includes at least one of event logs, input/output context, and system state information.
